(19) United States
(12) Patent Application Publication
(10) Pub. No.: US 2001/0035910 A1
(43) Pub. Date: Nov. 1, 2001

(54) Digital camera

(76) Inventors: Kazuhiko Yukawa, Sakai-Shi (JP); Kazumi Yukawa, Sakai-shi (JP)

Correspondence Address: SIDLEY AUSTIN BROWN & WOOD, 717 NORTH HARWOOD, SUITE 3400, DALLAS, TX, 75201, US

(21) Appl. No.: 09/817,833

(22) Filed: Mar. 26, 2001

(30) Foreign Application Priority Data
Mar. 29, 2000 (JP) 2000-090310

(51) Int. Cl. H04N 5/232; H04N 5/235; G03B 13/00; G03B 7/00

(52) U.S. Cl. 348/349; 348/362

(57) ABSTRACT

A taking lens is driven in steps each producing movement of the taking lens through a distance greater than a depth of field, and an evaluation value is determined based on a captured image obtained from a CCD imaging device in each position to which the lens is driven. Then, a predetermined interpolation process is performed on a plurality of evaluation values obtained in respective positions to which the lens is driven to derive an in-focus position of the taking lens for bringing an in-focus plane into coincidence with an imaging plane. The taking lens is driven to the in-focus position to achieve an in-focus condition. This allows efficient determination of the in-focus position in a digital camera.

This application is based on application No. 2000-90310 filed in Japan, the contents of which are hereby incorporated by reference.

### BACKGROUND OF THE INVENTION

1. Field of the Invention

The present invention relates to a digital camera for capturing an image of a subject to generate image data and, more particularly, to an autofocus technique for a digital camera.

2. Description of the Background Art

In recent years, the density of pixels of a CCD (Charge Coupled Device) imaging device for use in a digital camera has been on the increase. This leads to the advent of CCD imaging devices each having millions of pixels. The increase in pixel density of the CCD imaging device decreases a pitch between pixels.

Thus, a digital camera employing a CCD imaging device having pixels arranged at a higher density than ever is smaller in permissible circle of confusion and is therefore required to provide a higher accuracy of detection of an in-focus position (at which a lens is positioned to provide an in-focus image) for autofocus (also simply referred to hereinafter as “AF”).

In an image capturing device such as a video camera, on the other hand, a technique known as a contrast method (or a hill-climbing method) has been conventionally applied to autofocus. The contrast method is such that the contrast of a captured image is obtained as an evaluation value in each position of a focusing lens being driven to move, and a lens position in which the maximum evaluation value is obtained is defined as the in-focus position.

However, in the field of video cameras and the like which are intended for capturing moving images, a CCD imaging device employs on the order of hundreds of thousands of pixels, and has a large permissible circle of confusion. Therefore, the video camera is not required to provide the high accuracy for autofocus. If focus is achieved too quickly during the image capturing of the video camera, user's eyes cannot follow frequent focus movements responsive to the motions of the camera and the subject. This results in video images which give the impression of being visually unnatural to the user. In this manner, autofocus characteristics required of the video camera differ from those of still images.

In contrast, a digital camera for capturing still images is desired to achieve quick focus so as not to miss a shutter release opportunity.

For a digital camera including a CCD imaging device of high pixel density which is required to accurately determine the in-focus position, it is necessary to repeatedly drive the lens to move a fine pitch based on the depth of field depending on the permissible circle of confusion to detect the lens position in which the maximum evaluation value is obtained.

Application of the conventional contrast-based autofocus method to the digital camera including the CCD imaging device of high pixel density causes the lens to be driven a large number of times, to require much time to determine the in-focus position, resulting in user's failure to take a shutter release opportunity.

In particular, a grossly out-of-focus condition requires an enormous amount of time to determine the in-focus position, and therefore necessitates efficient autofocus to prevent the user from missing a shutter release opportunity.

### SUMMARY OF THE INVENTION

The present invention is intended for a digital camera.

According to one aspect of the present invention, the digital camera comprises: an imaging device including a two-dimensional array of pixels for receiving an optical image of a subject to generate an image signal; a driver for driving a taking lens in steps each producing movement of the taking lens through a distance greater than a depth of field; a calculator for calculating an evaluation value based on the image signal obtained from the imaging device in each position to which the taking lens is driven; a processor for performing an interpolation process upon a plurality of evaluation values obtained in respective positions to which the taking lens is driven to determine an in-focus position of the taking lens; and a controller for controlling the driver to drive the taking lens to the in-focus position, based on a processing result from the processor.

Therefore, this digital camera is capable of efficiently determining the in-focus position and moving the taking lens to the in-focus position within a short time and with high accuracy.

According to another aspect of the present invention, the digital camera comprises: an imaging device including a two-dimensional array of pixels for receiving an optical image of a subject to generate an image signal; a first driver for driving a taking lens; a second driver for driving a diaphragm having a variable aperture diameter; and a controller for controlling the first driver to drive the taking lens, with the diaphragm adjusted to a first aperture diameter smaller than a second aperture diameter by controlling the second driver, to calculate an evaluation value based on a captured image obtained from the imaging device in each position to which the taking lens is driven, thereby determining a direction in which the taking lens is to be driven.

Even if the taking lens is grossly far away from the in-focus position, this digital camera can easily judge the direction in which the taking lens is to be driven toward the in-focus position, to efficiently move the taking lens to the in-focus position.

The present invention is also intended for a method of controlling autofocus.

According to one aspect of the present invention, the method comprises the steps of: receiving an optical image of a subject at an imaging device including a two-dimensional array of pixels to generate an image signal; driving a taking lens in steps each producing movement of the taking lens through a distance greater than a depth of field; calculating an evaluation value based on the image signal obtained from the imaging device in each position to which the taking lens is driven; performing an interpolation process upon a plurality of evaluation values obtained in respective positions to which the taking lens is driven to determine an in-focus position of the taking lens; and driving the taking lens to the determined in-focus position.

According to another aspect of the present invention, the method comprises the steps of: receiving an optical image of a subject at an imaging device including a two-dimensional array of pixels to generate an image signal; calculating a change in evaluation value based on the image signal obtained from the imaging device before and after the taking lens is driven; adjusting a diaphragm to a first aperture diameter smaller than a second aperture diameter when the change in evaluation value is less than a predetermined value; and calculating an evaluation value based on a captured image obtained from the imaging device, with the diaphragm adjusted to the first aperture diameter, to determine a direction in which the taking lens is to be driven.

It is therefore an object of the present invention to provide a digital camera capable of efficiently determining an in-focus position.

These and other objects, features, aspects and advantages of the present invention will become more apparent from the following detailed description of the present invention when taken in conjunction with the accompanying drawings.

### BRIEF DESCRIPTION OF THE DRAWINGS

FIGS. 1 through 4 show an example of the outer appearance of a digital camera;

FIG. 5 is a functional block diagram of the digital camera;

FIG. 6 schematically shows an arrangement of parts of an image capturing section;

FIG. 7 shows an example of a captured image;

FIG. 8 shows an autofocus area;

FIG. 9 shows the concept of autofocus;

FIG. 10 is a graph showing a form of lens drive in a first method of autofocus control;

FIG. 11 is a graph in the case of a small change in evaluation value near an in-focus position;

FIG. 12 is a graph showing a form of lens drive in a second method of autofocus control;

FIG. 13 shows a first interpolation process in the second method of autofocus control;

FIG. 14 shows a second interpolation process in the second method of autofocus control;

FIG. 15 shows a third interpolation process in the second method of autofocus control;

FIG. 16 is a graph showing curves indicative of an evaluation value change before and after the control of a diaphragm in a third method of autofocus control; and

FIGS. 17 through 24 are flowcharts showing an example of a process sequence in the digital camera.

### DESCRIPTION OF THE PREFERRED EMBODIMENTS

A preferred embodiment of the present invention will now be described in detail with reference to the drawings.

<1. Construction of Digital Camera>

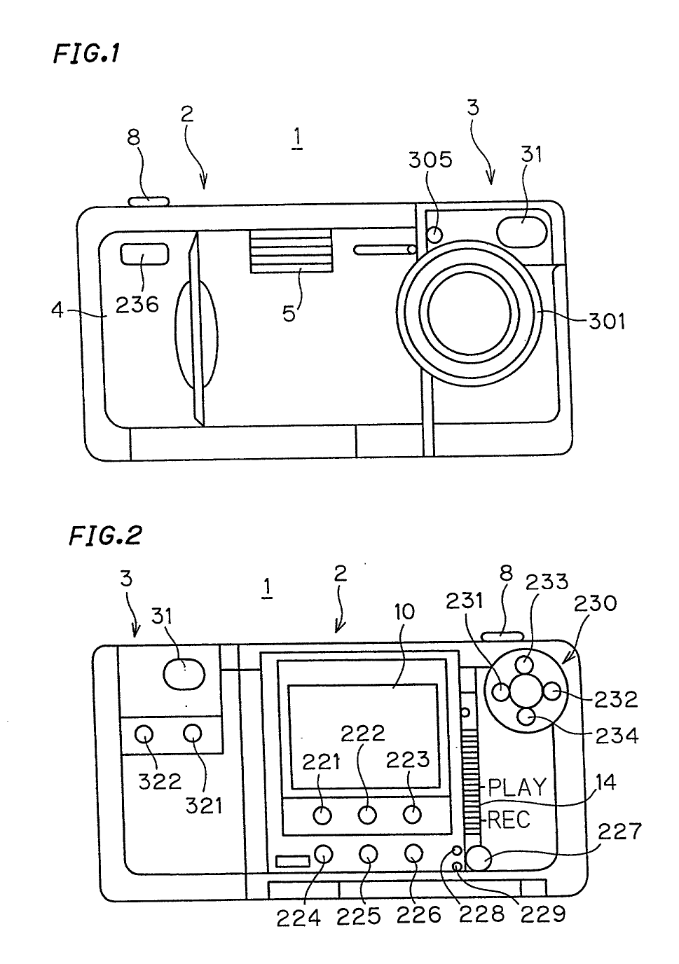

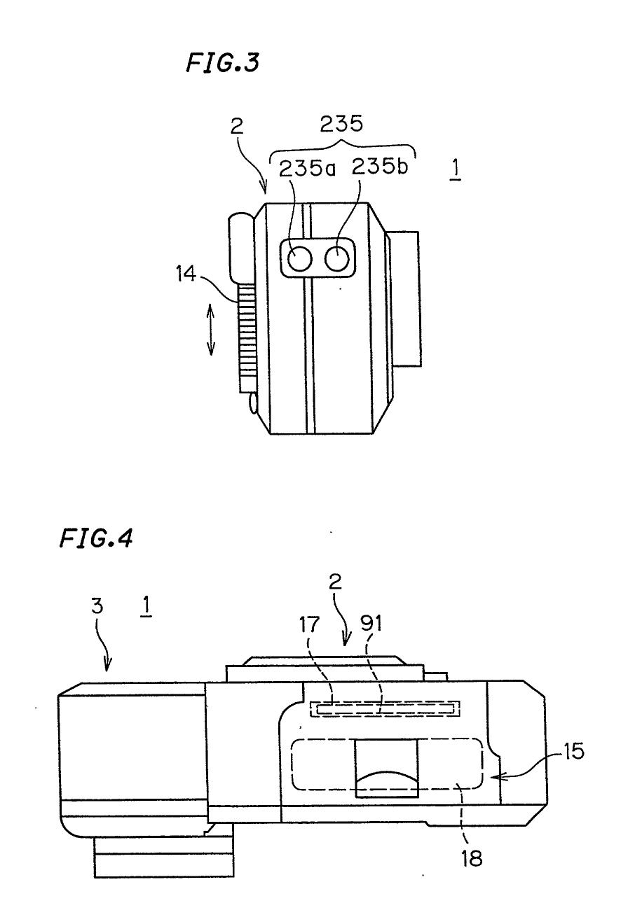

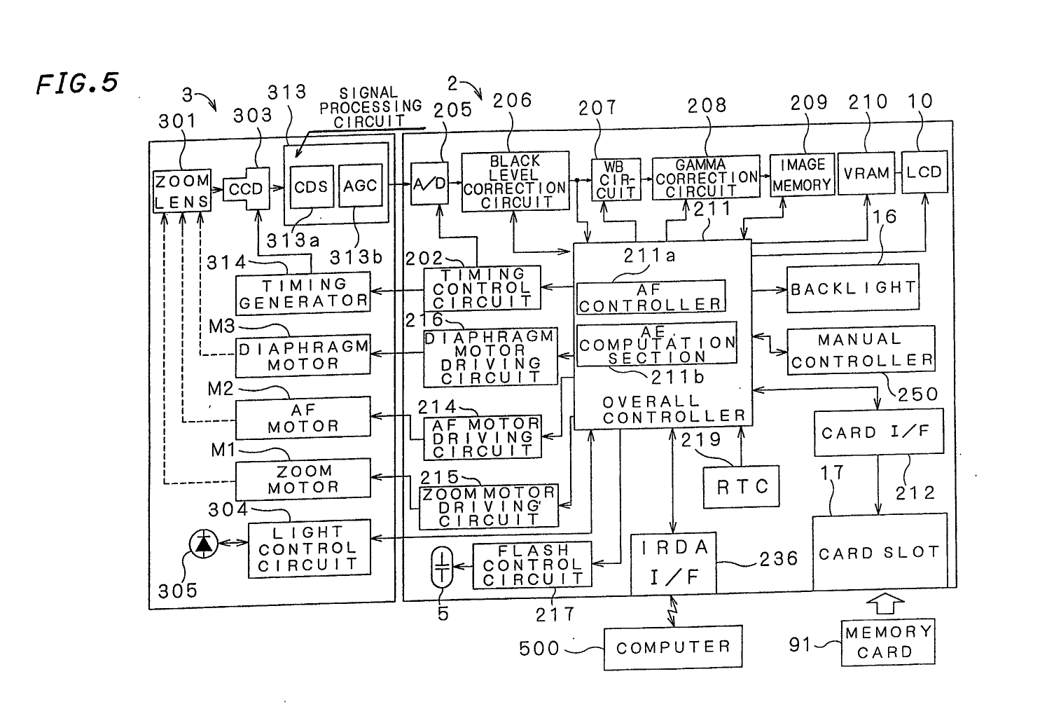

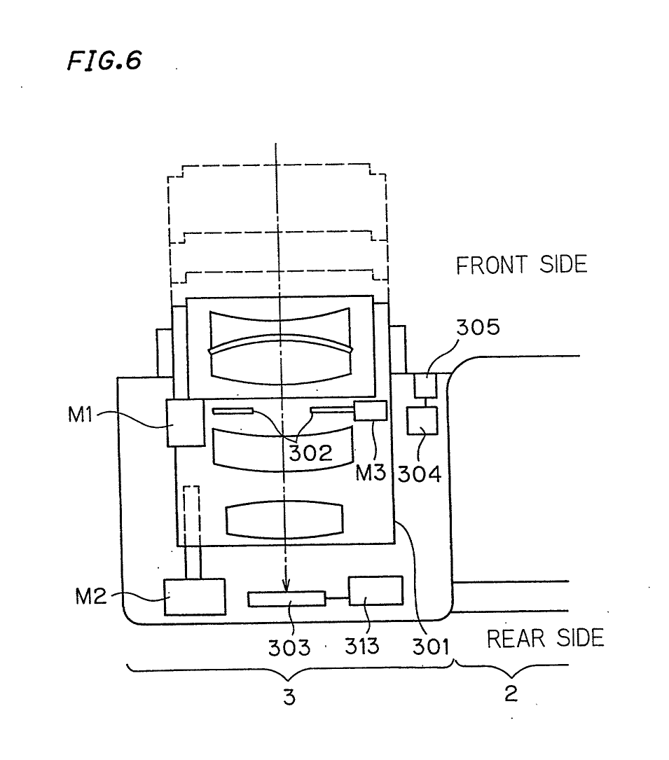

FIGS. 1 through 4 show an example of the outer appearance of a digital camera 1. FIG. 1 is a front view of the digital camera 1, FIG. 2 is a rear view thereof, FIG. 3 is a side view thereof, and FIG. 4 is a bottom view thereof.

As shown in FIG. 1, the digital camera 1 comprises a box-shaped camera body 2, and an image capturing section 3 having the shape of a rectangular parallelepiped.

The image capturing section 3 includes, on its front surface, a zoom lens 301 with macro capability serving as a taking lens, a light control sensor 305 for receiving flash light reflected from a subject, and an optical viewfinder 31. The light control sensor 305 and the optical viewfinder 31 are similar to those of a lens-shutter camera for silver halide film.

The camera body 2 includes, on its front surface, a grip 4 provided on its left-hand end, an IRDA (Infrared Data Association) interface 236 provided in an upper part of the grip 4 for conducting infrared communication with external equipment, and a built-in flash 5 provided in a median upper part of the front surface. The camera body 2 further includes a shutter release button 8 provided on the upper surface thereof.

With reference to FIG. 2, the rear surface of the camera body 2 includes a liquid crystal display (LCD) 10 in its generally midportion for producing a monitor display of a captured image (corresponding to a viewfinder) and displaying a playback of a recorded image and the like. Below the LCD 10 are provided a group of key switches 221 to 226 for user's manual operation of the digital camera 1, and a power switch 227. To the left of the power switch 227 are arranged an LED 228 which stays illuminated when power is on, and an LED 229 indicating that a memory card is being accessed.

The rear surface of the camera body 2 further includes a mode selection switch 14 for mode selection between a “recording mode” (“REC”) and a “playback mode” (“PLAY”). The recording mode is a mode for taking a picture to generate a captured image of the subject, and the playback mode is a mode for reading the captured image recorded on the memory card to display a playback of the captured image on the LCD 10.

The mode selection switch 14 is a two-position slide switch. Sliding the mode selection switch 14 to its bottom position places the recording mode into operation, and sliding the mode selection switch 14 to its top position places the playback mode into operation.

A four-way switch 230 with buttons 231, 232, 233 and 234 is provided in a right-hand position on the rear surface of the digital camera 1. In the recording mode, pressing the buttons 231 and 232 changes a zoom magnification, and pressing the buttons 233 and 234 effects exposure compensation.

The rear surface of the image capturing section 3 includes an LCD button 321 for turning on/off the LCD 10, and a macro button 322. The LCD display is switched on and off each time the LCD button 321 is pressed. For example, the LCD display is switched off for purposes of power saving when a user captures images using only the optical viewfinder 31. For macrophotography (close-up), the user presses the macro button 322 to allow the image capturing section 3 to perform macro photographing.

A side surface of the camera body 2 includes a terminal section 235, as shown in FIG. 3, which includes a DC input terminal 235a, and a video output terminal 235b for outputting information displayed on the LCD 10 to an external video monitor.

As illustrated in FIG. 4, the bottom surface of the camera body 2 includes a battery compartment 18 and a card slot (card compartment) 17. The card slot 17 receives a removable memory card 91 and the like for recording captured images and the like. The card slot 17 and the battery compartment 18 are openable/closable by a clamshell cover 15. This digital camera 1 is driven by a power battery having four in-series connected AA cells inserted in the battery compartment 18. Additionally, an adapter may be attached to the DC input terminal 235a shown in FIG. 3 to supply electric power to the digital camera 1 from the exterior thereof.

<2. Internal Components of Digital Camera>

Next, internal components of the digital camera will be discussed. FIG. 5 is a functional block diagram of the digital camera 1. FIG. 6 schematically shows an arrangement of parts of the image capturing section 3.

The image capturing section 3 comprises an image capturing circuit including a CCD imaging device 303 and disposed in place behind the zoom lens 301. In the image capturing section 3 are provided a zoom motor M1 for changing the zoom ratio of the zoom lens 301 and for moving the zoom lens 301 between a retracted position and an image capturing position, an autofocus motor (AF motor) M2 for achieving automatic focus, and a diaphragm motor M3 for adjusting the aperture diameter of a diaphragm 302 provided inside the zoom lens 301. The zoom motor M1, the AF motor M2 and the diaphragm motor M3 are driven by a zoom motor driving circuit 215, an AF motor driving circuit 214 and a diaphragm motor driving circuit 216, respectively, which are provided in the camera body 2. The driving circuits 214 to 216 drive the respective motors M1 to M3, based on control signals given from an overall controller 211 of the camera body 2.

The CCD imaging device 303 converts an optical image of a subject which is image-formed by the zoom lens 301 into an electrical image signal (comprised of a sequence of pixel signals from respective pixels which have detected light) having R (red), G (green) and B (blue) color components to output the image signal.

Exposure control in the image capturing section 3 is performed by adjusting the aperture of the diaphragm 302 and the amount of light exposure in the CCD imaging device 303, i.e., the charge storage time in the CCD imaging device 303 corresponding to a shutter speed. If the aperture and the shutter speed are not properly set in a low subject contrast condition, incorrect exposure because of underexposure is corrected by level adjustment of the image signal outputted from the CCD imaging device 303. That is, in the low subject contrast condition, the exposure control is performed by using the aperture, shutter speed and gain adjustment in combination to provide a correct exposure level. The level adjustment of the image signal is made by the gain control of an AGC (Auto Gain Control) circuit 313b in a signal processing circuit 313.

A timing generator 314 generates a drive control signal for the CCD imaging device 303, based on a reference clock transmitted from a timing control circuit 202 in the camera body 2. The timing generator 314 generates clock signals such as an integration start/end (exposure start/end) timing signal and read control signals (a horizontal sync signal, a vertical sync signal, a transfer signal, and the like) for light detection signals of respective pixels, to output the clock signals to the CCD imaging device 303.

The signal processing circuit 313 performs predetermined analog signal processing upon the image signal (analog signal) outputted from the CCD imaging device 303. The signal processing circuit 313 comprises a CDS (correlated double sampling) circuit 313a and the AGC circuit 313b. The signal processing circuit 313 reduces noises in the image signal in the CDS circuit 313a, and adjusts the gain in the AGC circuit 313b to adjust the level of the image signal.

A light control circuit 304 controls the amount of light emitted from the built-in flash 5 for flash photography to a predetermined amount established by the overall controller 211. In the flash photography, the light control sensor 305 detects the flash light reflected from the subject at the same time as the start of exposure, and the light control circuit 304 outputs a light emission stop signal when the amount of flash light detected by the light control sensor 305 reaches the predetermined amount. The light emission stop signal is directed through the overall controller in the camera body 2 to a flash control circuit 217. In response to the light emission stop signal, the flash control circuit 217 forces the built-in flash 5 to stop emitting light. This allows the control of the amount of light emitted from the built-in flash 5 to the predetermined amount.

Next, internal blocks of the camera body 2 will be described.

In the camera body 2, an A/D converter 205 converts each of the pixel signals included in the image signal into, for example, a 10-bit digital signal. The A/D converter 205 converts each of the pixel signals (analog signals) into the 10-bit digital signal, based on a clock for A/D conversion inputted from the timing control circuit 202.

The timing control circuit 202 generates the reference clock for the timing generator 314 and the A/D converter 205. The timing control circuit 202 is controlled by the overall controller 211 comprising a CPU (Central Processing Unit).

A black level correction circuit 206 corrects the black level of the A/D converted captured image to a predetermined reference black level. A WB (white balance) circuit 207 converts the level of pixel data about the R, G and B color components so that white balance is also adjusted after gamma correction. The WB circuit 207 uses a level conversion table inputted from the overall controller 211 to convert the level of the pixel data about the R, G and B color components. The conversion factor (the gradient of a characteristic curve) for each color component in the level conversion table is established for each captured image by the overall controller 211.

A gamma correction circuit 208 corrects the gamma characteristic of the captured image. An image memory 209 is a memory for storing captured image data outputted from the gamma correction circuit 208. The image memory 209 is capable of storing data about one frame. In other words, the image memory 209 has a pixel data storage capacity of n×m pixels when the CCD imaging device 303 has pixels arranged in n rows and m columns, and stores these pixel data in corresponding pixel locations.

A VRAM (video RAM) 210 is a buffer memory for the captured image whose playback is to be displayed on the LCD 10. The VRAM 210 has an image data storage capacity corresponding to the number of pixels in the LCD 10.

In an image capturing standby state in the recording mode, a live view display is produced on the LCD 10 when the LCD display is in the on state by pressing the LCD button 321. More specifically, each of the captured images obtained at predetermined time intervals from the image capturing section 3 is subjected to various signal processing in the A/D converter 205, the black level correction circuit 206, the WB circuit 207 and the gamma correction circuit 208. Thereafter, the overall controller 211 obtains a captured image to be stored in the image memory 209 and transfers the captured image to the VRAM 210 to display the captured image on the LCD 10. The live view display is produced by updating the captured images to be displayed on the LCD 10 at predetermined time intervals. The live view display allows the user to view the images displayed on the LCD 10 to visually identify a subject image. When an image is displayed on the LCD 10, a backlight 16 stays illuminated under the control of the overall controller 211.

In the playback mode, an image read from the memory card 91 is subjected to predetermined signal processing in the overall controller 211, and then transferred to the VRAM 210. Thus, a playback of the image is displayed on the LCD 10.

A card interface 212 is an interface for writing and reading the captured image therethrough into and from the memory card 91.

The flash control circuit 217 is a circuit for controlling the light emission from the built-in flash 5. The flash control circuit 217 forces the built-in flash 5 to emit the flash light, based on a control signal from the overall controller 211, and forces the built-in flash 5 to stop emitting the flash light, based on the above-mentioned light emission stop signal.

An RTC (real time clock) 219 is a clock circuit for managing the date and time of photographing.

A manual controller 250 includes the above-mentioned various switches and buttons. Information manually inputted by the user is transmitted through the manual controller 250 to the overall controller 211.

The shutter release button 8 is a two-position switch capable of detecting a half-pressed position and a full-pressed position as used in conventional cameras for silver halide film.

The overall controller 211 functions as a control means for controlling the drive of the above-mentioned components in the image capturing section 3 and the camera body 2 to exercise centralized control over the image capturing operation of the digital camera 1.

The overall controller 211 comprises an AF (autofocus) controller 211a for controlling the operation for efficient automatic focusing, and an AE (auto exposure) computation section 211b for performing automatic exposure.

The AF controller 211a receives the captured image outputted from the black level correction circuit 206, and determine an evaluation value for use in autofocusing. Then, the AF controller 211a evaluates the evaluation value to control the components of the digital camera 1, thereby positioning the zoom lens 301 so as to provide an in-focus image on the image capturing surface of the CCD imaging device 303.

The AE computation section 211b also receives the captured image outputted from the black level correction circuit 206, and computes proper values of the shutter speed (SS) and the aperture diameter of the diaphragm 302, based on a predetermined program. Based on the subject contrast, the AE computation section 211b computes the proper values of the shutter speed (SS) and the aperture diameter of the diaphragm 302 in accordance with the predetermined program.

In the recording mode, after receiving an instruction to capture an image from the shutter release button 8, the overall controller 211 generates, from the image received by the image memory 209, a thumbnail image and a JPEG compressed image at a compression rate inputted through a switch included in the manual controller 250, and stores in the memory card 91 the thumbnail and compressed images with tag information about the captured image (e.g., frame number, exposure value, shutter speed, compression rate, the date and time of photographing, flash on/off data at photo taking, scene information, and the result of judgment about the image).

When the mode selection switch 14 for selection between the recording mode and the playback mode is in the “playback mode” position, image data of the highest frame number in the memory card 91 is read out, and is decompressed in the overall controller 211. This captured image is transferred to the VRAM 210. Thus, the image of the highest frame number or the latest captured image is displayed on the LCD 10.

The overall controller 211 is adapted to conduct infrared wireless communication with external equipment 500 such as a computer and other digital cameras through the IRDA interface 236, and is capable of conducting wireless transfer of the captured image and the like.

For autofocusing in the digital camera 1 constructed as above mentioned, the AF controller 211a extracts an image component contained in a predetermined area of the captured image provided from the black level correction circuit 206, and calculates an autofocus evaluation value from the image component.

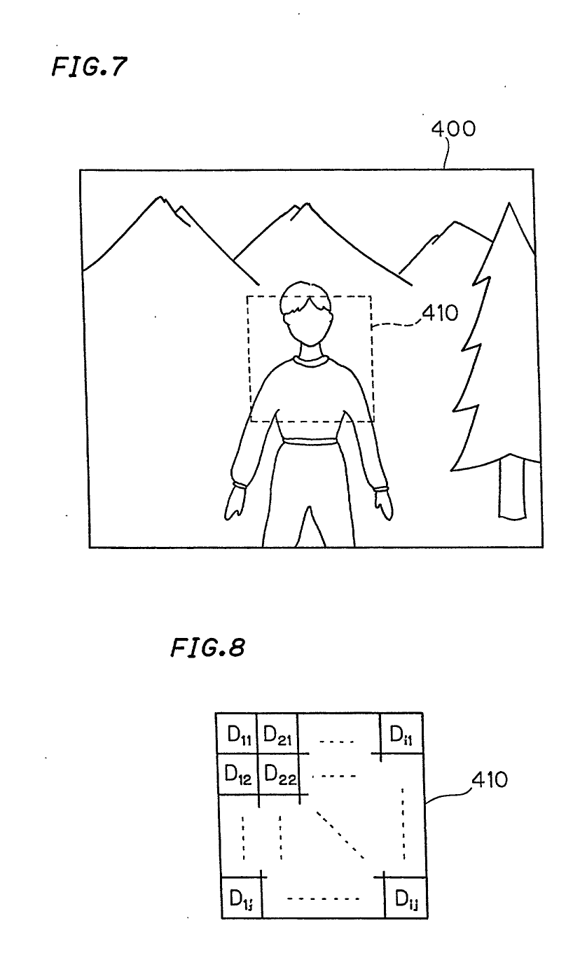

FIG. 7 shows an example of the captured image. FIG. 8 shows an autofocus area.

With reference to FIG. 7, when a captured image 400 is obtained from the black level correction circuit 206, an autofocus area 410 is defined substantially in the center of the captured image 400. The autofocus area 410 has an array of pixels arranged in j rows and i columns, as illustrated in FIG. 8.

Thus, upon receiving the captured image 400 from the black level correction circuit 206, the AF controller 211a extracts an image component having i×j pixels contained in the autofocus area 410.

Then, the AF controller 211a calculates the autofocus evaluation value based on the values of the respective pixels contained in the autofocus area 410. More specifically, the evaluation value C is calculated by

$$C = {\sum }_{x = 1}^{i - 1} {\sum }_{y = 1}^{j} \vert {D}_{xy} - {D}_{x + 1 , y} \vert \qquad ( 1 )$$

where D is data about each pixel. Equation (1) is the summation of data differences between horizontally adjacent pixels in the autofocus area 410. The evaluation value C corresponds to horizontal contrast of the extracted image component. Although Equation (1) shows calculation for extracting the horizontal contrast, vertical contrast may be determined or contrast in a two-dimensional space may be determined in consideration for both the horizontal and vertical directions. Using the contrast thus determined as the evaluation value, the AF controller 211a performs an autofocus control operation.

In general, when a taking lens is in an in-focus position, a captured image in the CCD imaging device 303 has high definition and high contrast. Conversely, when the taking lens is not in the in-focus position, the captured image is blurred and has low definition and low contrast. Using the contrast as the evaluation value, the AF controller 211a may perform the autofocus control in such a manner as to determine the maximum evaluation value while driving the zoom lens 301 to move and to define a lens position in which the maximum evaluation value is reached as the in-focus position.

For autofocusing while driving the zoom lens 301, it is necessary to drive a focusing lens included in the zoom lens 301 to move a distance not greater than the depth of field.

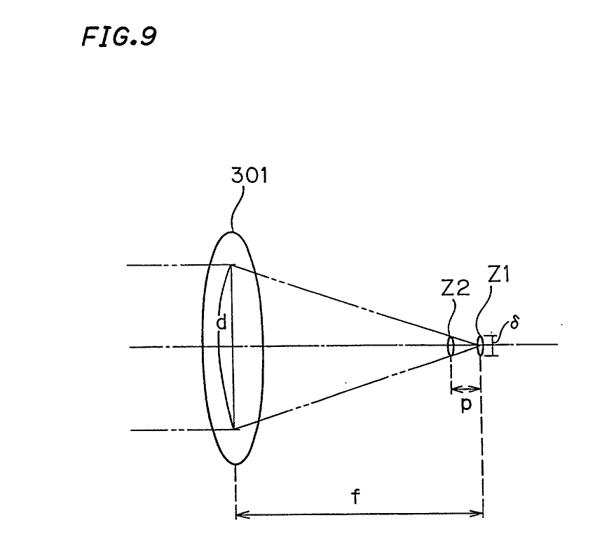

FIG. 9 shows the concept of autofocus. As illustrated in FIG. 9, when the diaphragm 302 included in the zoom lens 301 has an aperture diameter d and the zoom lens 301 has a focal length f, the subject image is image-formed at a position Z1 shown in FIG. 9. In the digital camera 1, since a pixel-to-pixel pitch (spacing) of the CCD imaging device 303 is considered to correspond to the permissible circle of confusion δ, the zoom lens 301 is in the in-focus position when a light receiving surface is in the position Z1. However, since the permissible circle of confusion δ has a constant size, the subject image is also image-formed within one pixel even when the light receiving surface is in a position Z2. Thus, the zoom lens 301 is in the in-focus position when the light receiving surface is in any position within the range from the position Z1 to the position Z2. Therefore, a distance p between the positions Z1 and Z2 is equal to the depth of field, and is expressed as p=Fδ since the f-number F (corresponding to an aperture value) of the zoom lens 301 is expressed as F=f/d.

In other words, for high-accuracy determination of the in-focus position in autofocusing while driving the zoom lens 301, it is necessary to drive the focusing lens to move a distance such that the amount of movement of an in-focus plane is equal to or less than the depth of field p. The zoom lens 301 in this preferred embodiment is configured to be capable of driving the focusing lens to move a fine pitch P such that the amount of movement of the in-focus plane by the AF motor M2 equals the depth of field p=Fδ.

However, the CCD imaging device 303 including a plurality of pixels arranged at a higher density on the image capturing surface has a lower value of δ. Thus, driving the focusing lens to move the fine pitch P increases the number of times the focusing lens is driven to prolong the time required to bring the focusing lens into the in-focus position. The digital camera 1 in this preferred embodiment controls the operation to be described below to carry out efficient autofocus.

<3. Autofocus Control>

<3-1. First Method of Autofocus Control>

A first method of autofocus control is described below.

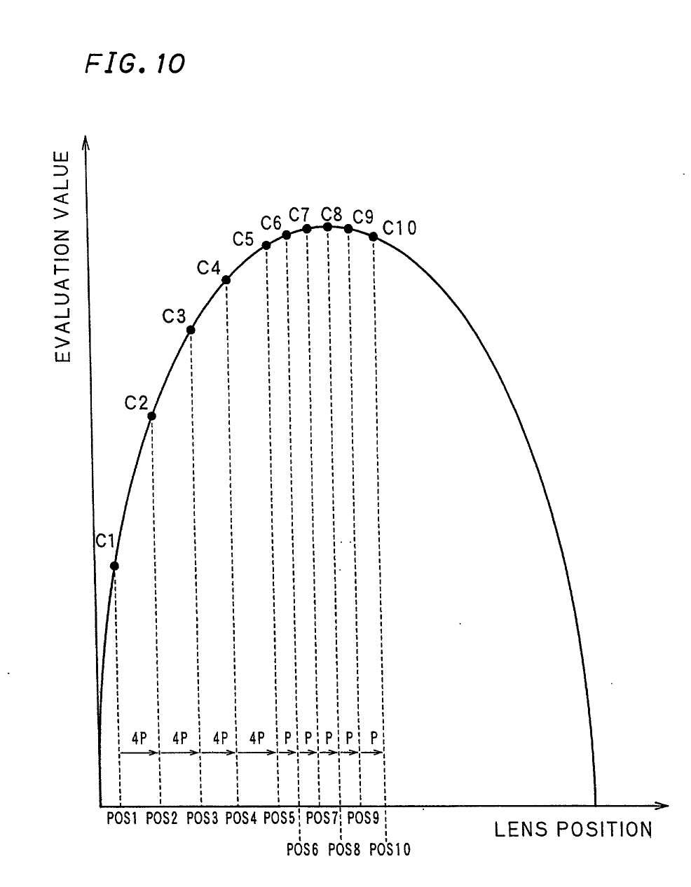

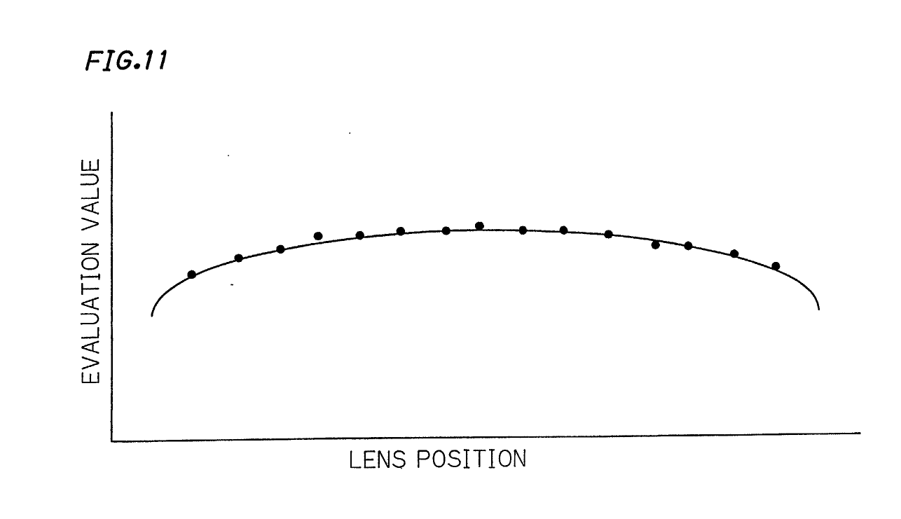

FIG. 10 is a graph showing a form of lens drive in the first method of autofocus control. To achieve an in-focus condition, the lens is initially driven to a lens position POS1 corresponding to an infinite position, as shown in FIG. 10. In the lens position POS1, the AF controller 211a derives an evaluation value Cl of the image component contained in the autofocus area 410 from the captured image by computation using Equation (1) or the like.

Next, the AF controller 211 a sends a predetermined control signal to the AF motor driving circuit 214 to drive the AF motor M2, thereby moving the focusing lens in the zoom lens 301. The distance PT of movement of the lens at this time is set so that the amount of movement of the in-focus plane is greater than the depth of field p=Fδ. As an example, it is assumed herein that the distance PT is four times the fine pitch P, i.e. PT=4P, so that the amount of movement of the in-focus plane equals 4Fδ which is greater than the depth of field p=Fδ. If the distance PT of movement of the lens is equal to the amount of movement of the in-focus plane, then PT=4Fδ. It should be noted that the distance PT is not limited to 4P.

Next, upon moving the lens to a lens position POS2, the AF controller 211a determines an evaluation value C2 again from the captured image obtained in the lens position POS2. If C2>C1, the evaluation value rises as the lens is moved. Then, it is found that the lens is driven and directed toward the in-focus position.

Additionally, if the amount of change in evaluation value ΔC=|C2−C1| is greater than a predetermined value, it is found that the lens position is widely spaced apart from the in-focus position. This is because the in-focus position is the lens position which maximizes the evaluation value and an evaluation value curve exhibits a small change near the in-focus position, as shown in FIG. 10.

Then, the AF controller 211a drives the lens in a similar manner to move the distance PT=4P to lens positions POS3, POS4, . . . , and determines evaluation values C3, C4, . . . in succession from the captured image obtained in the respective lens positions.

When the evaluation value obtained in each current lens position is greater than the evaluation value obtained in the preceding lens position as a result of comparison therebetween and the amount of change in evaluation value is not greater than the predetermined value, it is found that the current lens position is near the in-focus position. Then, the AF controller 211a changes the distance PT of movement of the lens to the fine pitch P to determine the in-focus position more accurately.

In the instance shown in FIG. 10, the amount of change in evaluation value obtained in a lens position POS5 is not greater than the predetermined value, and the distance PT of subsequent lens movement is set at PT=P. Then, the AF controller 211a drives the lens to move the distance PT=P to lens positions POS6, POS7, POS8, . . . , and determines evaluation values C6, C7, C8 . . . in succession from the captured image obtained in the respective lens positions.

When the evaluation value obtained in the current lens position is less than the evaluation value obtained in the preceding lens position, it is found that the lens is moved past the lens position which maximizes the evaluation value. However, it can be estimated that the evaluation value obtained in the current lens position is less than the evaluation value obtained in the preceding lens position accidentally because of the influence of noises.

This preferred embodiment is adapted to drive the lens twice past the lens position POS8 which maximizes the evaluation value, as illustrated in FIG. 10. If the evaluation value in a lens position POS9 is less than its preceding evaluation value for the first time, a possibility that such a fall in evaluation value results from the influence of noises is estimated, and the lens is driven again. If the evaluation value obtained in a lens position POS10 is also less than its preceding evaluation value, it is judged that noises have little influence because of the tendency of the evaluation value to fall twice in succession, and the lens position POS8 which maximizes the evaluation value is determined as the in-focus position. Thereafter, the focusing lens is moved to the lens position POS8 to carry out high-accuracy autofocus.

Thus, the autofocus control method as illustrated in FIG. 10 can drive the lens efficiently since the lens is driven to move a greater distance when the lens is greatly far away from the in-focus position. Additionally, changing the distance of lens movement to the fine pitch P when the lens comes near the in-focus position allows high-accuracy detection of the in-focus position.

<3-2. Second Method of Autofocus Control>

A second method of autofocus control is described below.

The first method of autofocus control has the need to repeatedly drive the lens to move the fine pitch P near the in-focus position, to require longer time, although shorter than ever, to achieve an in-focus condition near the in-focus position.

Further, a difficulty occurs even if the lens is repeatedly driven to move the distance PT set at the fine pitch P near the in-focus position as in the first method of autofocus control. For example, when the subject image has a low spatial frequency such as in the case of a captured image containing a thick line within the autofocus area, a wide distribution of an image portion having a small change in evaluation value is present near the in-focus position, making it difficult to determine the correct in-focus position. FIG. 11 is a graph showing a change in evaluation value near the in-focus position in such a situation. As illustrated in FIG. 11, when the change in evaluation value is small near the in-focus position, the evaluation value is susceptible to noises, and it is difficult to determine the correct in-focus position even if the fine pitch P is used as the distance PT of lens movement.

To eliminate the difficulty, the second method of autofocus control is such that the distance PT of movement of the lens is set so that the amount of movement of the in-focus plane is always greater than the depth of field p=Fδ. To avoid the reduction in accuracy of the in-focus position resulting from the greater distance PT of lens movement even near the in-focus position, the second method of autofocus control performs an interpolation process on the evaluation value obtained for each distance PT to achieve high-accuracy determination of the in-focus position.

The second method of autofocus control is described in detail below. As an example, it is assumed herein that the distance PT is four times the fine pitch P, i.e. PT=4P, so that the amount of movement of the in-focus plane equals 4Fδ which is always greater than the depth of field p=Fδ.

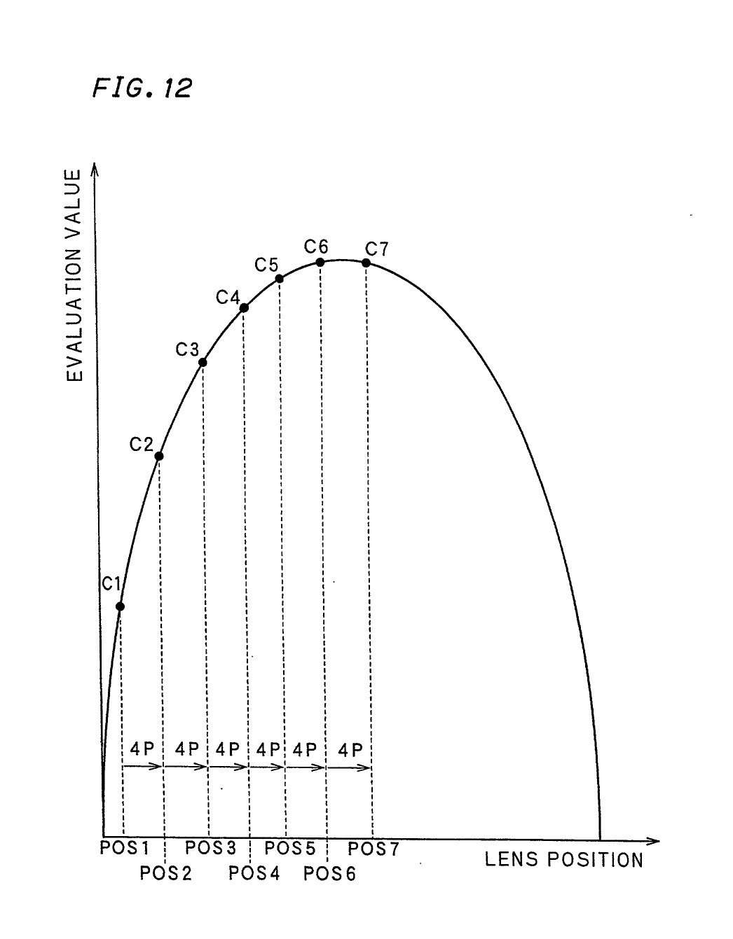

FIG. 12 is a graph showing a form of lens drive in the second method of autofocus control. To achieve an in-focus condition, the lens is initially driven to the lens position POS1 corresponding to an infinite position, as shown in FIG. 12. In the lens position POS1, the AF controller 211a derives the evaluation value C1 of the image component contained in the autofocus area 410 from the captured image by computation using Equation (1) or the like.

Next, the AF controller 211a sends the predetermined control signal to the AF motor driving circuit 214 to drive the AF motor M2, thereby moving the focusing lens in the zoom lens 301 through the distance PT=4P.

Next, upon moving the lens to the lens position POS2, the AF controller 211a determines the evaluation value C2 again from the captured image obtained in the lens position POS2. If C2>C1, the evaluation value rises as the lens is moved. Then, it is found that the lens is driven and directed toward the in-focus position.

Then, the AF controller 211a drives the lens in a similar manner to move the distance PT=4P to the lens positions POS3, POS4, . . . , and determines the evaluation values C3, C4, . . . in succession from the captured image obtained in the respective lens positions.

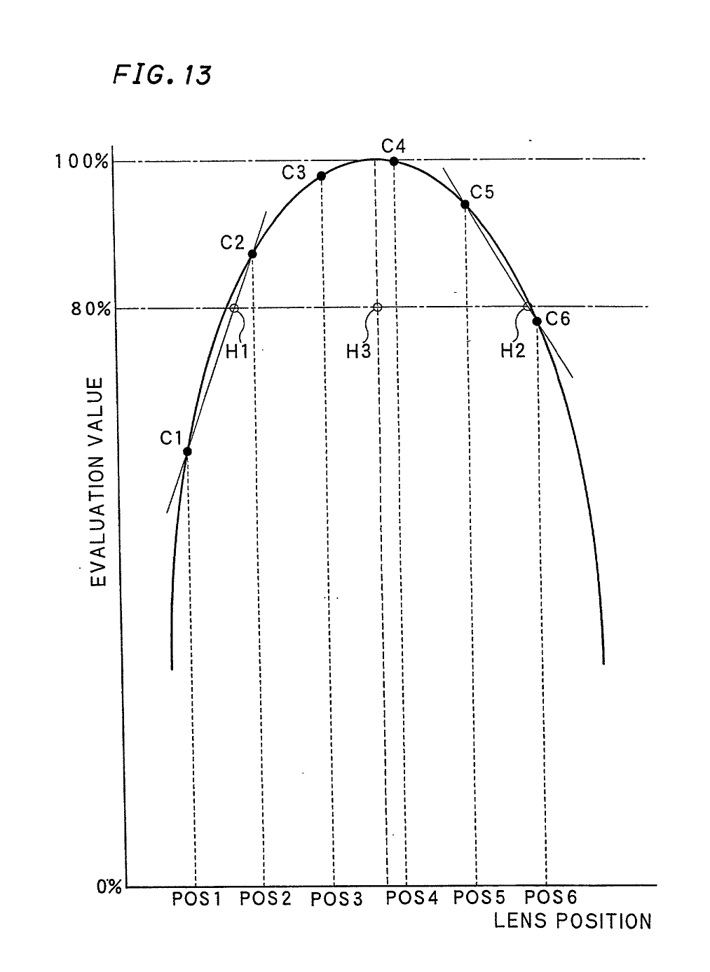

FIG. 13 shows a first interpolation process in the second method of autofocus control. The AF controller 211a repeatedly drives the lens to move the distance PT=4P as described above, and determines the maximum of the evaluation values obtained in the respective lens positions. In the case shown in FIG. 13, the evaluation value C4 obtained in the lens position POS4 is the maximum evaluation value.

The AF controller 211a calculates a value equivalent to 80% of the maximum evaluation value assumed as 100% to determine a pair of lens positions in which the evaluation value equals the 80% value on opposite sides of, i.e. in front of and behind, the lens position which maximizes the evaluation value. However, since the lens is driven in coarse steps each producing movement of the lens through the distance PT=4P, the evaluation value equivalent to 80% of the maximum evaluation value is not actually determined in many cases.

To solve the problem, the AF controller 211a determines two successive evaluation values above and below the 80% value, respectively, on each side of the lens position which maximizes the evaluation value on the evaluation value curve. In the case shown in FIG. 13, the evaluation values C1 and C2 are determined as the two successive evaluation values prior to the maximum evaluation value, and the evaluation values C5 and C6 are determined as the two successive evaluation values after the maximum evaluation value.

Then, the AF controller 211a determines the lens positions in which the evaluation value equals the 80% value by linear interpolation. More specifically, the AF controller 211a connects the point of the evaluation value C1 obtained in the lens position POS1 and the point of the evaluation value C2 obtained in the lens position POS2 by a straight line, and determines a lens position H1 at which the straight line intersects the 80% level. Similarly, the AF controller 211a connects the point of the evaluation value C5 obtained in the lens position POS5 and the point of the evaluation value C6 obtained in the lens position POS6 by a straight line, and determines a lens position H2 at which the straight line intersects the 80% level.

The AF controller 211a then calculates the midpoint H3 between the lens positions H1 and H2 to determine the lens position of the midpoint H3 as the in-focus position. Thereafter, moving the focusing lens to the lens position of the midpoint H3 achieves high-accuracy autofocus. For the movement of the focusing lens to the lens position of the midpoint H3, the distance PT is set at a value suitable for directing the focusing lens to the lens position of the midpoint H3.

Thus, the lens is driven in coarse distance steps to obtain the evaluation values, and the in-focus position is determined by the interpolation process based on the evaluation values obtained in the respective steps. This eliminates the need to drive the lens to move the fine pitch near the in-focus position, and also reduces the influence of noises if the change in evaluation value is small near the in-focus position, thereby achieving high-speed and high-accuracy determination of the in-focus position. One of the features of this interpolation process is the shorter time required for computation. Therefore, this interpolation process is effective at efficiently determining the in-focus position.

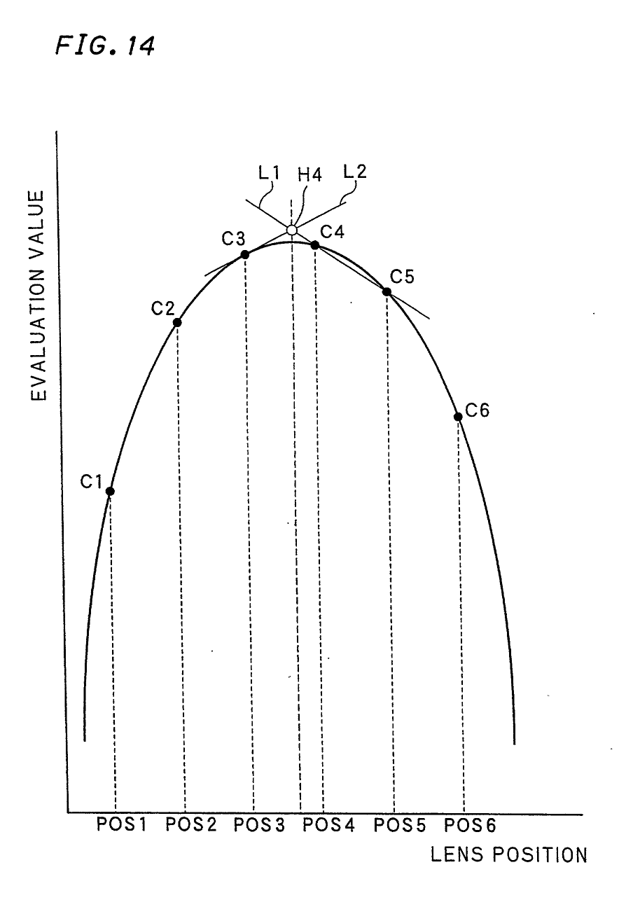

A second interpolation process will be described. FIG. 14 shows the second interpolation process in the second method of autofocus control. The AF controller 211a repeatedly drives the lens to move the distance PT=4P as described above, and determines the maximum, the second highest and the third highest of the evaluation values obtained in the respective lens positions. In the case shown in FIG. 14, the evaluation value C4 obtained in the lens position POS4 is the maximum evaluation value, the evaluation value C3 obtained in the lens position POS3 is the second highest evaluation value, and the evaluation value C5 obtained in the lens position POS5 is the third highest evaluation value. The AF controller 211a determines these evaluation values C4, C3 and C5.

The AF controller 211a performs an interpolation process based on a steep inclination extension method upon the evaluation values C4, C3 and C5 and the lens positions POS4, POS3 and POS5 to determine the in-focus position. More specifically, the AF controller 211a selects two points among the three points so that a straight line connecting the two points is inclined at the steepest angle, and extends the steeply inclined straight line connecting the two points. Additionally, the AF controller 211a defines a straight line which passes through the remaining one point and which is inclined at the same angle as the steeply inclined straight line but in the opposite direction (or which has an inclination different only in sign). The intersection of these two lines is determined as the in-focus position.

In the case shown in FIG. 14, a straight line L1 passing through the point of the evaluation value C4 obtained in the lens position POS4 and the point of the evaluation value C5 obtained in the lens position POS5 is defined as the steeply inclined straight line, and a straight line L2 passing through the point of the evaluation value C3 obtained in the lens position POS3 is defined as the straight line inclined in the opposite direction from the steeply inclined straight line L1. A lens position of the intersection H4 of the extensions of the straight lines L1 and L2 is determined as the in-focus position.

Thereafter, moving the focusing lens to the lens position of the intersection H4 achieves high-accuracy autofocus. For the movement of the focusing lens to the lens position of the intersection H4, the distance PT is set at a value suitable for directing the focusing lens to the lens position of the intersection H4.

The interpolation process based on the steep inclination extension method described above is effective at efficiently determining the in-focus position because of the shorter time required for computation. If there is a need to further increase the focusing accuracy, the AF controller 211a may drive the lens to move the fine pitch P near the in-focus position (intersection H4) determined by the steep inclination extension method to make a search for a lens position which maximizes the evaluation value as in the normal contrast method. However, this gives rise to the need to drive the lens to move the fine pitch P a plurality of times, requiring longer time, although shorter than ever, to achieve an in-focus condition.

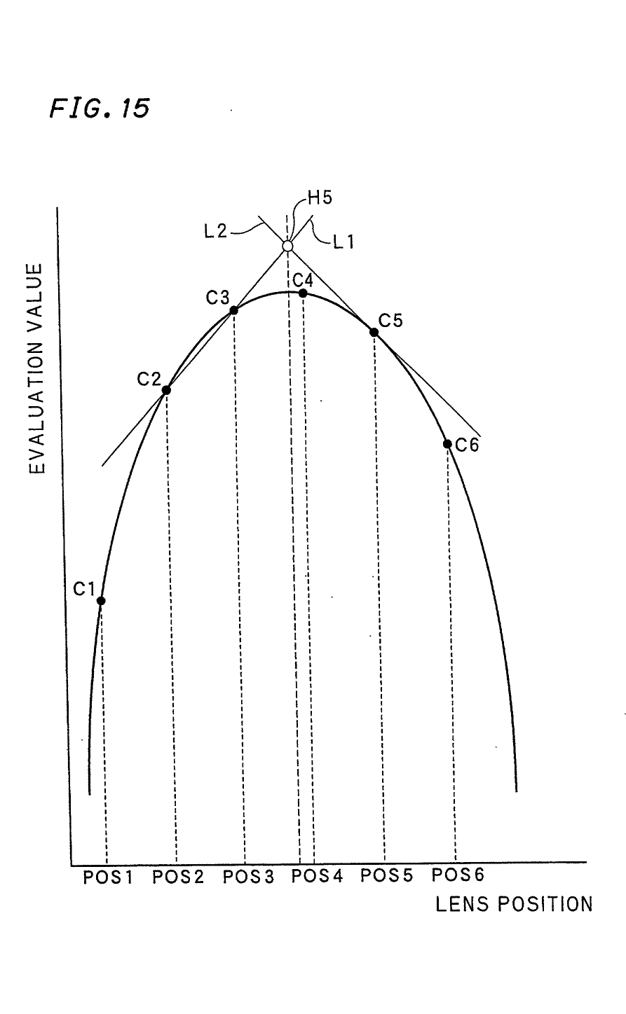

A third interpolation process will be described. FIG. 15 shows the third interpolation process in the second method of autofocus control. The AF controller 211a repeatedly drives the lens to move the distance PT=4P as described above, and determines three higher evaluation values except the maximum, i.e. the second, third and fourth highest of the evaluation values obtained in the respective lens positions. In the case shown in FIG. 15, the evaluation value C3 obtained in the lens position POS3 is the second highest evaluation value, the evaluation value C5 obtained in the lens position POS5 is the third highest evaluation value, and the evaluation value C2 obtained in the lens position POS2 is the fourth highest evaluation value. The AF controller 211a determines these evaluation values C3, C5 and C2.

The AF controller 211a performs the interpolation process based on the steep inclination extension method similar to that described above upon the evaluation values C3, C5 and C2 and the lens positions POS3, POS5 and POS2 to determine the in-focus position. More specifically, in the case shown in FIG. 15, the straight line L1 passing through the point of the evaluation value C3 obtained in the lens position POS3 and the point of the evaluation value C2 obtained in the lens position POS2 is defined as the steeply inclined straight line, and the straight line L2 passing through the point of the evaluation value C5 obtained in the lens position POS5 is defined as the straight line inclined in the opposite direction from the steeply inclined straight line L1. A lens position of the intersection H5 of the extensions of the straight lines L1 and L2 is determined as the in-focus position.

Thereafter, moving the focusing lens to the lens position of the intersection H5 achieves high-accuracy autofocus. For the movement of the focusing lens to the lens position of the intersection H5, the distance PT is set at a value suitable for directing the focusing lens to the lens position of the intersection H5.

This interpolation process based on the steep inclination extension method has a tendency toward the decrease in interpolation accuracy, as compared with the interpolation process using the maximum evaluation value. However, this interpolation process based on the steep inclination extension method which excludes the maximum evaluation value which is susceptible to noises is an effective method having an increased interpolation accuracy if a large noise component is present.

As stated above, the second method of autofocus control comprises driving the lens in coarse distance steps when obtaining the evaluation values, performing the interpolation process based on the evaluation values obtained in the respective steps to determine the in-focus position, and moving the focusing lens to the in-focus position. This eliminates the need to drive the lens to move the fine pitch near the in-focus position. Additionally, this method can achieve the high-speed and high-accuracy determination of the in-focus position because of efficient computation.

The second method of autofocus control may be used in combination with the first method of autofocus control.

<3-3. Third Method of Autofocus Control>

A third method of autofocus control is described below.

The first and second methods of autofocus control in which the evaluation value changes as the lens is driven are effective methods when the direction of hill climbing of the evaluation values can be judged as the lens is driven.

However, in such a case where the lens position is very far away from the in-focus position, the first and second methods of autofocus control produce significantly blurred captured images to provide small evaluation values indicating contrast, and also provide a very small change in evaluation value before and after movement of the lens even if the distance PT is set at a large value (e.g., PT=4P).

Thus, even if the first and second methods of autofocus control are performed, it might be found that the lens went away from the in-focus position after the lens was driven a plurality of times in the direction opposite from the hill climbing direction. It is therefore difficult to carry out efficient autofocus.

To overcome the difficulty, the third method of autofocus control provides a form of control which can effectively determine the direction in which the lens is to be driven (referred to hereinafter as a “lens drive direction”) toward the in-focus position even if small evaluation values are obtained and a small change in evaluation value occurs as the lens is driven.

When it is impossible to derive the evaluation values before and after the lens movement and to determine the lens drive direction toward the in-focus position from these evaluation values, the AF controller 211a sends a predetermined control signal to the diaphragm motor driving circuit 216 to reduce the aperture diameter of the diaphragm 302 included in the zoom lens 301. For example, when the F-number of the zoom lens 301 is 2.8, the AF controller 211a sends the control signal to change the F-number to 5.6.

This increases the depth of field p (=Fδ), to allow an increase in evaluation value change.

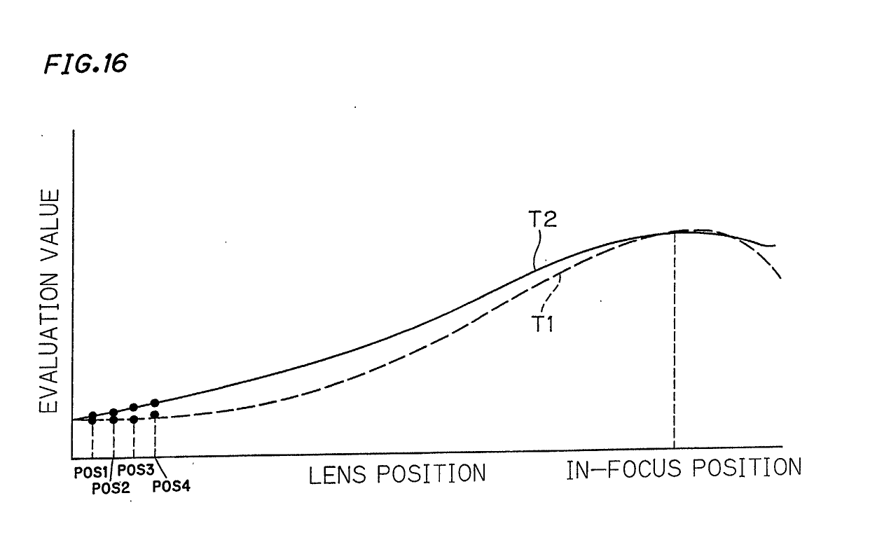

FIG. 16 is a graph showing curves indicative of a change in evaluation value before and after the control of the aperture of the diaphragm 302. In FIG. 16, the broken curve is an evaluation value change curve T1 before the aperture of the diaphragm 302 is made smaller (e.g., F=2.8), and the solid curve is an evaluation value change curve T2 after the aperture of the diaphragm 302 is made smaller (e.g., F=5.6).

As illustrated in FIG. 16, even in the case where a low-contrast evaluation value change, for example, in the lens positions POS1 to POS4 is not satisfactorily detected using the evaluation value change curve T1, increasing the depth of field p by making the aperture of the diaphragm 302 smaller provides an inclination to the evaluation value change as indicated by the evaluation value change curve T2, allowing satisfactory detection of the evaluation value change.

Consequently, in which direction the lens is to be driven to approach the in-focus position is easily found, and the lens drive direction is efficiently determined.

With the aperture of the diaphragm 302 made smaller, the greater field of depth p results in a smaller change in evaluation value near the in-focus position. Then, after the lens is driven to the vicinity of the in-focus position, the AF controller 211a sends a predetermined control signal to the diaphragm motor driving circuit 216 to make the aperture of the diaphragm 302 greater, thereby controlling the field of depth p to be shallower. This provides a greater change in evaluation value near the in-focus position to achieve a greater evaluation value change by driving the lens to move a slight distance, thereby allowing the high-accuracy determination of the in-focus position.

As described above, the third method of autofocus control performs control to make the aperture of the diaphragm 302 smaller in order to determine the lens drive direction toward the in-focus position. This provides a greater depth of field, thereby to achieve a relatively greater change in evaluation value in a lens position where the evaluation value changes by a small amount. Therefore, such control achieves efficient determination of the lens drive direction toward the in-focus position, to allow high-speed autofocus.

However, in the third method of autofocus control, making the aperture diameter of the diaphragm 302 smaller than, for example, a proper value results in a lower exposure value of the captured image obtained by the CCD imaging device 303. This reduces the brightness of the captured image, and it is accordingly contemplated that autofocus is difficult to perform suitably. In such a case, in order to maintain the exposure value at a proper level, the gain value set by the AGC circuit 313b or the charge storage time corresponding to the shutter speed of the CCD imaging device 303 may be increased in accordance with the f-number of the diaphragm 302, thereby to prevent the reduction in exposure value and to achieve efficient detection of the lens drive direction toward the in-focus position by increasing the field of depth p.

The third method of autofocus control may be used in combination with the first and second methods of autofocus control.

<4. Process Sequence of Autofocus Control>

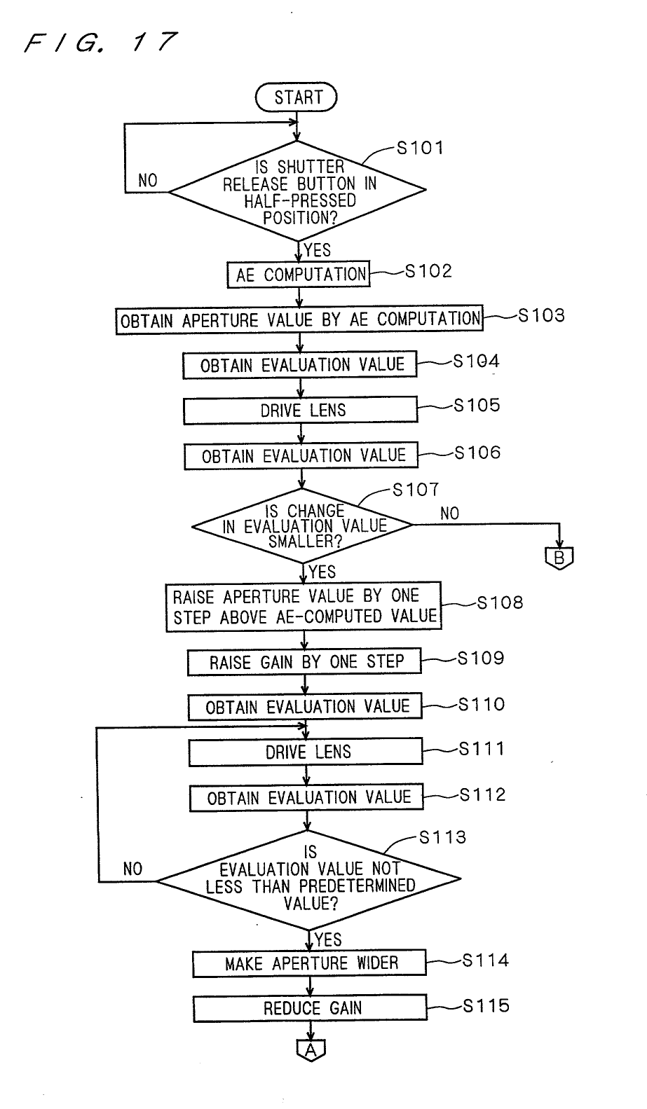

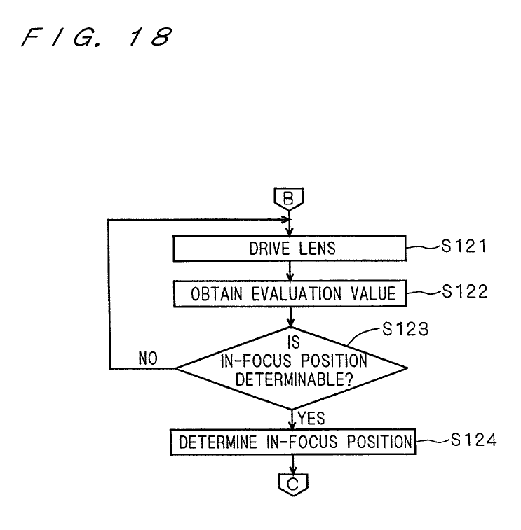

Description will be given on a process sequence when putting autofocusing in practice in the digital camera 1. FIGS. 17 through 19 are flowcharts showing a process sequence of autofocusing when the digital camera 1 captures an image.

First, the overall controller 211 judges whether or not the user presses the shutter release button 8 included in the manual controller 250 in the half-pressed position (Step S101). If the shutter release button 8 is in the half-pressed position, the process proceeds to Step S102 for autofocus control.

The AE computation section 211b in the overall controller 211 functions to perform an AE computation based on a captured image given from the black level correction circuit 206 to determine an aperture value and a shutter speed for proper exposure (Step S102). The diaphragm motor driving circuit 216 and the diaphragm motor M3 drive the diaphragm 302 based on the result of computation to adjust the diaphragm 302 to an aperture value based on the computation (Step S103). In this process, the charge storage time of the CCD imaging device 303 is also set based on the result of computation.

Then, the AF controller 211a functions to compute the autofocus evaluation value based on the captured image obtained before the zoom lens 301 is driven (Step S104). The AF controller 211a drives the zoom lens 301 (Step S105), and then obtains the captured image again to determine the evaluation value (Step S106).

The AF controller 211a makes a comparison between the evaluation values before and after the lens is driven to judge whether or not the change in evaluation value is smaller than a reference value (Step S107). The evaluation value change smaller than the reference value means that it is impossible to determine the direction in which the zoom lens 301 is to be driven toward the in-focus position. On the other hand, the evaluation value change greater than the reference value means that the evaluation value change allows the determination of the direction in which the zoom lens 301 is to be driven toward the in-focus position.

If the result of judgement is YES in Step S107, the AF controller 211a raises a setting of the aperture value of the diaphragm 302, for example, by one step above the aperture value obtained by the AE computation (Step S102) to reduce a setting of the aperture diameter of the diaphragm 302 by one step (Step S108) in order to determine the lens drive direction toward the in-focus position.

The reduction in the aperture diameter of the diaphragm 302 reduces the exposure value below the proper exposure value. To achieve proper exposure of the captured image obtained by the CCD imaging device 303, the AF controller 211a raises a setting of the gain value in the AGC circuit 313b by one step above a predetermined value (Step S109). Similar effects are produced by increasing the charge storage time in the CCD imaging device 303 in place of increasing the gain value.

The process in Steps S108 and S109 can increase the depth of field to produce the evaluation value change to a degree sufficient for determination of the lens drive direction toward the in-focus position.

Then, the AF controller 211a derives the evaluation value (Step S110), drives the lens (Step S111), and derives the evaluation value again (Step S112). The AF controller 211a makes a comparison between the evaluation values obtained in Steps S110 and S112 to determine the lens drive direction toward the in-focus position. Until the evaluation value is not less than a predetermined value which indicates that the lens is near the in-focus position, the AF controller 211a repeatedly drives the lens toward the in-focus position and obtains the evaluation value (Step S113).

When the evaluation value is not less than the predetermined value, it is found that the lens position is near the in-focus position. To bring the lens position into coincidence with the in-focus position with high accuracy, the AF controller 211a increases the aperture diameter of the diaphragm 302 to decrease the depth of field (Step S102) in Step S114. In this step, the AF controller 211a makes the aperture wider than that corresponding to the aperture value obtained by the AE computation (Step S102). This provides the depth of field shallower than that obtained during actual image capturing to achieve high-accuracy determination of the in-focus position.

Next, the AF controller 211a reduces the gain value in the AGC circuit 313b (Step S115) in order to maintain the exposure value at a proper level in accordance with the increase in aperture diameter of the diaphragm 302. When adjusting the charge storage time, the AF controller 211a reduces the charge storage time.

With reference to the flowchart of FIG. 19, the AF controller 211a obtains the evaluation value (Step S131), drives the lens (Step S132), and obtains the evaluation value again (Step S133). In step S134, the AF controller 211a judges whether or not the in-focus position is determinable, depending on whether or not the evaluation value has passed over the maximum. If the evaluation value has not yet passed over the maximum and the in-focus position is not determinable, the AF controller 211a repeats the operation in Steps S132 to S134 to repeatedly drives the lens and obtains the evaluation value. On the other hand, if the in-focus position is determinable, the process proceeds to Step S135.

In Step S135, the AF controller 211a determines the in-focus position, and brings the lens position into coincidence with the in-focus position. In this step, the AF controller 211a performs the above-mentioned interpolation and drives the lens to move the fine pitch P, as required, to determine the in-focus position with high accuracy.

After bringing the lens position of the zoom lens 301 into coincidence with the in-focus position, the AF controller 211a returns the setting of the aperture value of the diaphragm 302 to the aperture value obtained by the AE computation (Step S102) in Step S136, and returns the setting of the gain value in the AGC circuit 313b to the predetermined original value in Step S137. When the charge storage time is adjusted, the AF controller 211a returns the charge storage time to its original time.

After the above-mentioned operation, the digital camera 1 is in a state of readiness to capture a subject image, and the role of the AF controller 211a comes to an end. Then, the overall controller 211 detects whether or not the shutter release button 8 is pressed in the full-pressed position by the user (Step S138).

If the shutter release button 8 is pressed in the full-pressed position, the overall controller 211 performs an image capturing process including performing various image processing upon the captured image obtained by the CCD imaging device 303 and storing the captured image in the image memory 209 (Step S139). The overall controller 211 records the captured image stored in the image memory 209 on the memory card 91 to terminate the process (Step S140).

Even in the case where the lens drive direction toward the in-focus position is not determinable, the above-mentioned sequence of process steps can easily determine the lens drive direction by making the aperture diameter of the diaphragm 302 smaller to efficiently move the lens to the in-focus position.

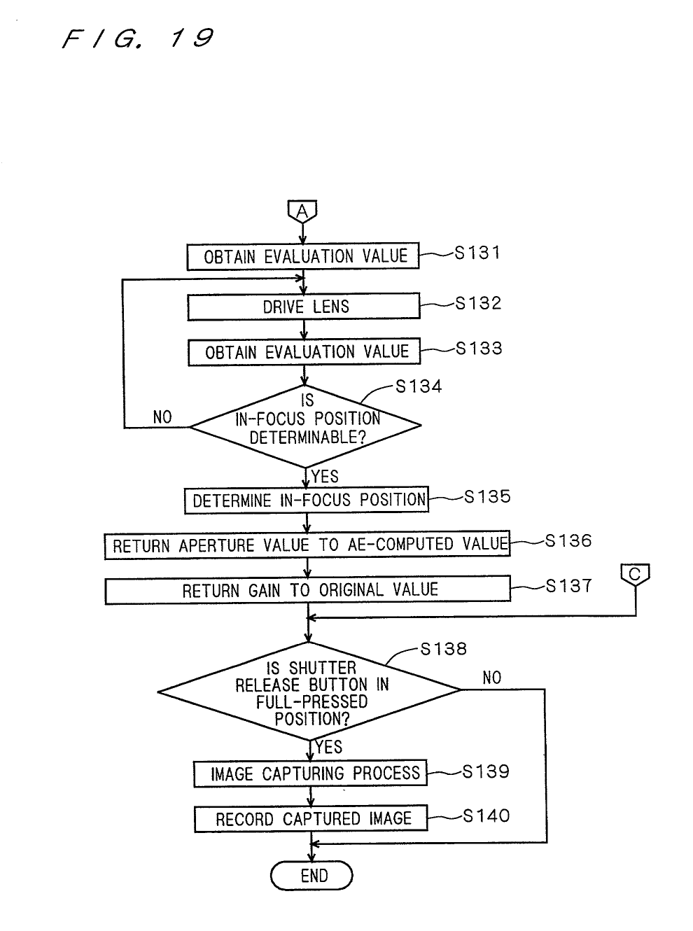

On the other hand, if the evaluation value change is greater than the reference value in Step S107, the process proceeds to the flowchart of FIG. 18. More specifically, the AF controller 211a determines the lens drive direction toward the in-focus position based on the evaluation value change to drive the lens in the lens drive direction (Step S121), obtains the evaluation value (Step S122), and judges whether or not the in-focus position is determinable (Step S123). The process in Step S123 is similar to that in Step S134 described above.

Then, the AF controller 211a determines the in-focus position, and brings the lens position into coincidence with the in-focus position (Step S124). The process in Step S124 is similar to that in Step S135 described above.

The process proceeds to Step S138 shown in FIG. 19. If the shutter release button 8 is pressed in the full-pressed position, the image capturing process (Step S139) is performed.

The above-mentioned operation sequence efficiently accomplishes autofocus when the user presses the shutter release button 8. The autofocus control may be effected not only when the user presses the shutter release button 8 but also when the power to the digital camera 1 is turned on and the live view display is in the on state at turn-on. Further, the autofocus control may be effected to quickly enable the image capturing operation when the mode is changed from the playback mode to the recording mode. Moreover, the autofocus control may be effected in preparation for continuous shooting after the image capturing process.

A process sequence in such situations will be described.

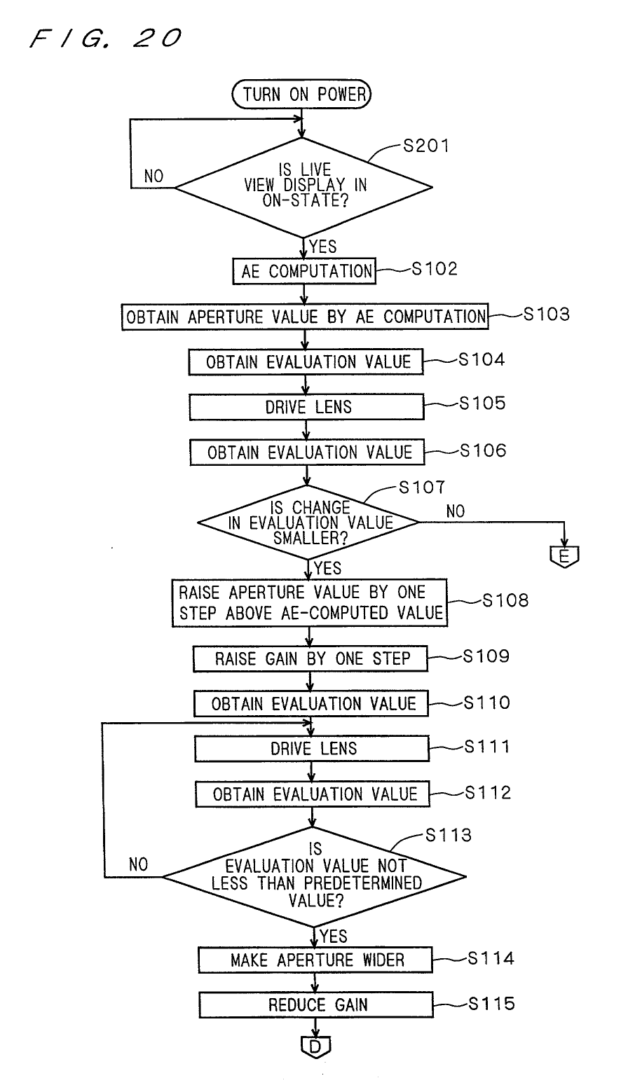

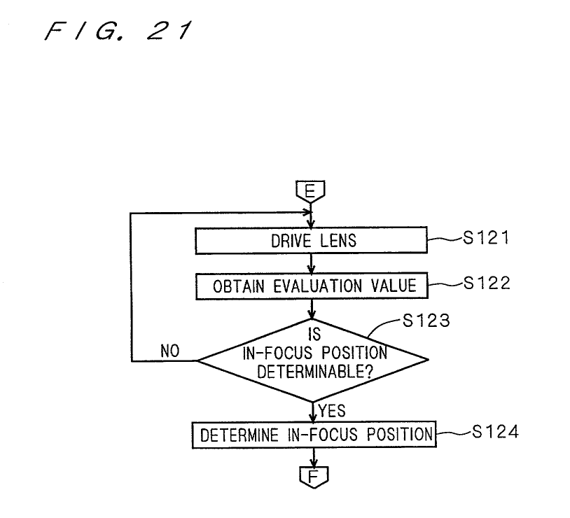

FIGS. 20 through 22 are flowcharts for autofocus control when the power to the digital camera 1 is turned on and the live view display is in the on state at turn-on. Steps in FIGS. 20 through 22 similar to those in FIGS. 17 through 19 are designated by the same reference characters, and are not particularly described again.

First, when the power to the digital camera 1 is turned on, the overall controller 211 judges whether or not the live view display is in the on state (Step S201). If the live view display is in the on state, process steps similar to those shown in FIGS. 17 through 19 (Steps S102 to S115, S121 to S124, and S131 to S137) are performed to efficiently determine the in-focus position and to move the zoom lens 301 to the in-focus position.

Then, the overall controller 211 produces a live view display of the in-focus captured image on the LCD 10 (Step S202).

Such processing allows the live view display of the in-focus captured image to be quickly produced on the LCD 10 after the power is turned on, to improve the operability of the digital camera 1.

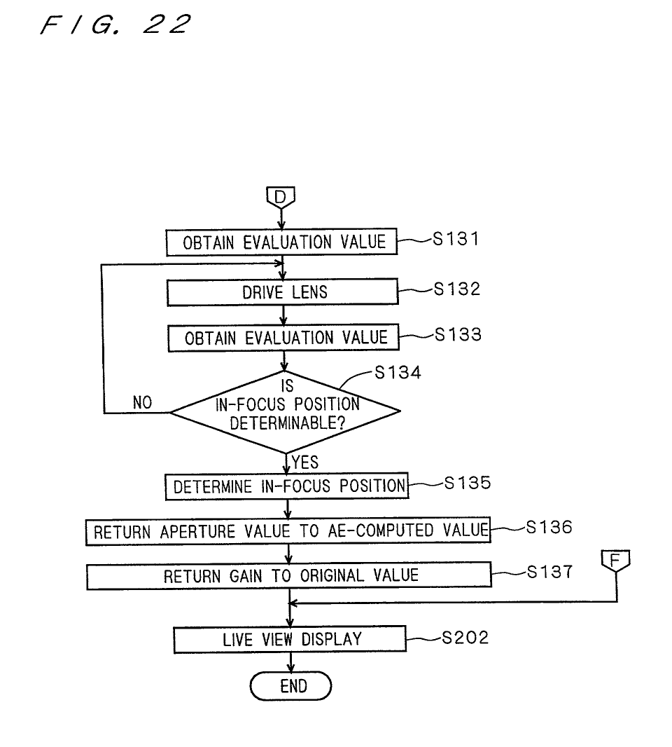

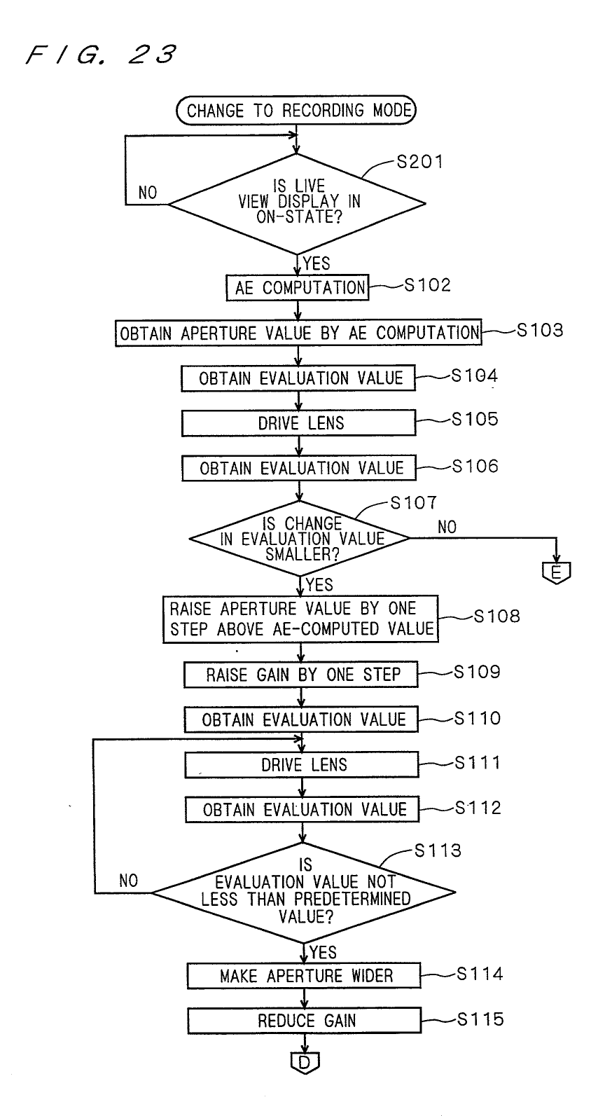

FIG. 23 is a flowchart for autofocus control when the mode is changed from the playback mode to the recording mode. Process steps subsequent to the flowchart of FIG. 23 are identical with those of FIGS. 21 and 22 to which reference is to be made. Steps in FIG. 23 similar to those described above are designated by the same reference characters, and are not particularly described again.

When the mode of the digital camera 1 is changed from the playback mode to the recording mode, the overall controller 211 judges whether or not the live view display is in the on state (Step S201). If the live view display is in the on state, process steps similar to those shown in FIGS. 20 through 22 (Steps S102 to S115, S121 to S124, and S131 to S137) are performed to efficiently determine the in-focus position and to move the zoom lens 301 to the in-focus position.

Then, the overall controller 211 produces a live view display of the in-focus captured image on the LCD 10 (See Step S202 of FIG. 22).

Such processing allows the live view display of the in-focus captured image to be quickly produced on the LCD 10 when the mode is changed to the recording mode, and also allows the preparation for the image capturing process. This improves the operability of the digital camera 1.

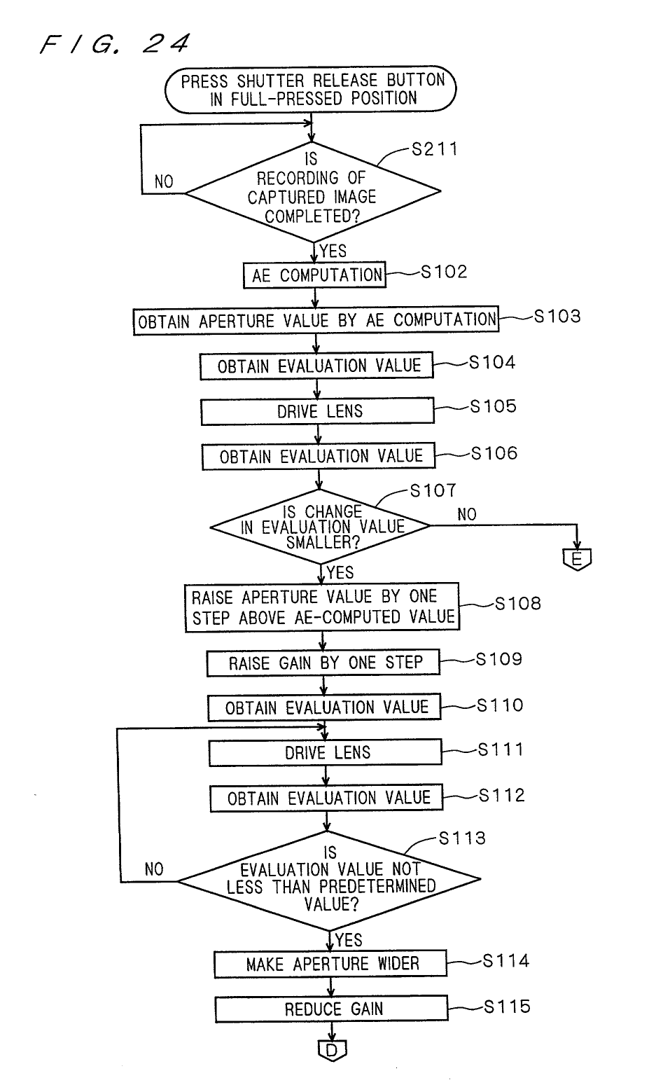

FIG. 24 is a flowchart for performing autofocus control again after the image capturing process. Process steps subsequent to the flowchart of FIG. 24 are identical with those of FIGS. 21 and 22 to which reference is to be made. Steps in FIG. 24 similar to those described above are designated by the same reference characters, and are not particularly described again.

After the shutter release button 8 is pressed in the full-pressed position, the overall controller 211 performs the image capturing process to record the captured image on the memory card 91, as described above. Then, the overall controller 211 judges whether or not the process of recording the captured image on the memory card 91 is completed (Step S211). If the recording process is completed, process steps similar to those shown in FIGS. 20 through 22 (Steps S102 to S115, S121 to S124, and S131 to S137) are performed to efficiently determine the in-focus position and to move the zoom lens 301 to the in-focus position.

Then, the overall controller 211 produces a live view display of the in-focus captured image on the LCD 10 (See Step S202 of FIG. 22).

Such processing allows the lens to be quickly driven to the in-focus position if the next image capturing is to be performed continuously after the image capturing process, to achieve improved operability. Additionally, the above-mentioned processing allows the live view display of the in-focus captured image to be quickly produced on the LCD 10 after the image capturing process, to improve the operability of the digital camera 1.

<5. Modifications>

Although the preferred embodiment of the present invention has been described above, the present invention is not limited to the above description.

For example, in the above description, the overall controller 211 receives the captured image from the black level correction circuit 206 to determine the autofocus evaluation value, but the present invention is not limited thereto. The captured image may be inputted from other components to the overall controller 211.

Although the zoom lens 301 is used as the taking lens in the above description, the taking lens is not limited to a zoom lens.

While the invention has been described in detail, the foregoing description is in all aspects illustrative and not restrictive. It is understood that numerous other modifications and variations can be devised without departing from the scope of the invention.

What is claimed is:

1. A digital camera comprising:
an imaging device including a two-dimensional array of pixels for receiving an optical image of a subject to generate an image signal;
a driver for driving a taking lens in steps each producing movement of said taking lens through a distance greater than a depth of field;
a calculator for calculating an evaluation value based on the image signal obtained from said imaging device in each position to which said taking lens is driven;
a processor for performing an interpolation process upon a plurality of evaluation values obtained in respective positions to which said taking lens is driven to determine an in-focus position of said taking lens; and
a controller for controlling said driver to drive said taking lens to said in-focus position, based on a processing result from said processor.

2. The digital camera according to claim 1,
wherein said driver drives said taking lens in steps each producing movement of said taking lens through a smaller distance than said distance near said in-focus position.

3. The digital camera according to claim 1,
wherein said interpolation process is performed based on evaluation values prior to and after a maximum evaluation value.

4. The digital camera according to claim 3,
wherein said interpolation process determines said in-focus position by a steep inclination extension method.

5. The digital camera according to claim 1,
wherein said evaluation value includes contrast of said image signal.

6. A digital camera comprising:
an imaging device including a two-dimensional array of pixels for receiving an optical image of a subject to generate an image signal;
a first driver for driving a taking lens;
a second driver for driving a diaphragm having a variable aperture diameter; and
a controller for controlling said first driver to drive said taking lens, with said diaphragm adjusted to a first aperture diameter smaller than a second aperture diameter by controlling said second driver, to calculate an evaluation value based on a captured image obtained from said imaging device in each position to which said taking lens is driven, thereby determining a direction in which said taking lens is to be driven.

7. The digital camera according to claim 6, further comprising
a calculator for performing an exposure computation to calculate a proper aperture value for proper exposure of said imaging device,
wherein said second aperture diameter is determined by said proper aperture value.

8. The digital camera according to claim 6, further comprising
an adjuster for adjusting a gain of said image signal obtained by said imaging device, said adjuster increasing said gain in accordance with a change in aperture diameter of said diaphragm which is made by said controller.

9. The digital camera according to claim 6, further comprising
an adjuster for adjusting charge storage time in said imaging device, said adjuster increasing said charge storage time in accordance with a change in aperture diameter of said diaphragm which is made by said controller.

10. The digital camera according to claim 6,
wherein said controller controls said second driver to increase the aperture diameter of said diaphragm when said taking lens is driven to near an in-focus position.

11. The digital camera according to claim 10, further comprising
a calculator for performing an exposure computation to calculate a proper aperture value for proper exposure of said imaging device,
wherein said controller controls said second driver to adjust said diaphragm to a third aperture diameter greater than the aperture diameter determined by said proper aperture value when said taking lens is driven to near said in-focus position.

12. The digital camera according to claim 10, further comprising
an adjuster for adjusting a gain of said image signal obtained by said imaging device, said adjuster decreasing said gain as said controller increases the aperture diameter of said diaphragm.

13. The digital camera according to claim 6,
wherein said controller controls said second driver to adjust said diaphragm to said first aperture diameter when the direction in which said taking lens is to be driven is not determinable.

14. The digital camera according to claim 6,
wherein said controller operates when receiving an instruction to capture an image.

15. The digital camera according to claim 6,
wherein said controller operates when power to said digital camera is turned on.

16. The digital camera according to claim 6,
wherein said controller operates after said captured image is recorded.

17. The digital camera according to claim 6,
wherein said controller operates when a recording mode is selected.

18. The digital camera according to claim 6,
wherein said evaluation value includes contrast of said image signal.

19. A method of controlling autofocus, comprising the steps of:
receiving an optical image of a subject at an imaging device including a two-dimensional array of pixels to generate an image signal;
driving a taking lens in steps each producing movement of said taking lens through a distance greater than a depth of field;
calculating an evaluation value based on the image signal obtained from said imaging device in each position to which said taking lens is driven;
performing an interpolation process upon a plurality of evaluation values obtained in respective positions to which said taking lens is driven to determine an in-focus position of said taking lens; and
driving said taking lens to said determined in-focus position.

20. A method of controlling autofocus, comprising the steps of:
receiving an optical image of a subject at an imaging device including a two-dimensional array of pixels to generate an image signal;
calculating a change in evaluation value based on the image signal obtained from said imaging device before and after said taking lens is driven;
adjusting a diaphragm to a first aperture diameter smaller than a second aperture diameter when said change in evaluation value is less than a predetermined value; and
calculating an evaluation value based on a captured image obtained from said imaging device, with said diaphragm adjusted to said first aperture diameter, to determine a direction in which said taking lens is to be driven.
